(19) United States
(12) Patent Application Publication
(10) Pub. No.: US 2009/0059334 A1
(43) Pub. Date: Mar. 5, 2009

(54) PROJECTION SYSTEM AND PORTABLE ELECTRONIC DEVICE USING SAME

(75) Inventor: MING-CHANG LIN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/147,495

(22) Filed: Jun. 27, 2008

(30) Foreign Application Priority Data
Aug. 30, 2007 (CN) 200710201522.8

(51) Int. Cl. G02B 26/10

(52) U.S. Cl. 359/198

(57) ABSTRACT

A projection system (108) includes a light source (110), a light modulating unit (120), a dynamic scanning unit (140) and a control circuit (150). The control circuit is electrically connected with the light source and the dynamic scanning unit. The control circuit is used to control the dynamic scanning unit to rotate at a rotating frequency. A monochromatic light is emitted from the light source, and collimated by the light modulating unit into parallel light. The dynamic scanning unit reflects and projects the parallel light incident thereupon.

### BACKGROUND

1. Technical Field

The present invention generally relates to projection systems, and particularly to a projection system to be used in a portable electronic device.

2. Description of the Related Art

Projection systems, such as liquid crystal display (LCD) projectors and digital light processing (DLP) projectors, have been widely used for work, entertainment, audio-visual education, among other uses.

Referring to FIG. 6, a typical projection system 400 includes a light source 410, a color separation optical system 420, a light modulating system 430, a light converging system 440, a projection lens 450 and an image signal source 460. During operation of the projection system 400, white light 412 emitted from the light source 410 is separated into three colored lights, i.e., red 412R, green 412G and blue 412B by the color separation optical system 420. The colored lights 412R, 412G and 412B enter into the light modulating system 430, and are modulated by the light modulating system 430 according to the image information inputted from the image signal source 460. Then, the light modulating system 430 outputs three colored light image signals 414R, 414G, 414B corresponding to the colored lights 412R, 412G, 412B. The three colored light image signals 414R, 414G, 414B are combined by the light converging system 440, and then projected through the projection lens 450 onto a screen 500 to form a visible colored image.

However, the color separation optical system 420, the light converging system 440 and the projection lens 450 are required in the projection system 400, which complicates the overall structure of the projection system 400 and limits the projection system 400 from being integrated into portable electronic devices. In addition, the light source 410 used in the projection system 400 suffers from high energy consumption and overheating. A heat dissipating device must be provided to cool the light source 410, which further complicates the overall structure and increases the cost of the projection system 400.

What is needed is a new projection system having a simple overall structure that can easily be integrated into portable electronic devices.

### SUMMARY

According to an exemplary embodiment, a projection system includes a light source, a light modulating unit, a dynamic scanning unit and a control circuit. The control circuit is electrically connected with the light source and the dynamic scanning unit. The control circuit is used to control the dynamic scanning unit to rotate at a rotating frequency. A monochromatic light is emitted from the light source, and collimated by the light modulating unit into parallel light. The dynamic scanning unit reflects and projects the parallel light incident thereupon.

Other advantages and novel features of the present projection system will become more apparent from the following detailed description of preferred embodiments when taken in conjunction with the accompanying drawings.

### BRIEF DESCRIPTION OF THE DRAWINGS

FIG. 1 is an isometric view of a portable electronic device including a projection system in accordance with an embodiment of the present invention.

FIG. 2 is an explanatory view showing a working principle of the projection system in the portable electronic device of FIG. 1.

FIG. 3 is an explanatory view showing different rotating positions of a dynamic scanning unit of the projection system of FIG. 2.

FIG. 4 is an explanatory view of a dynamic scanning unit of the projection system of FIG. 2, in accordance with another embodiment of the present invention.

FIG. 5 is an explanatory view of a projection system of the portable electronic device of FIG. 1, in accordance with another embodiment of the present invention.

FIG. 6 is a block diagram showing a working principle of a projection system in accordance with the related art.

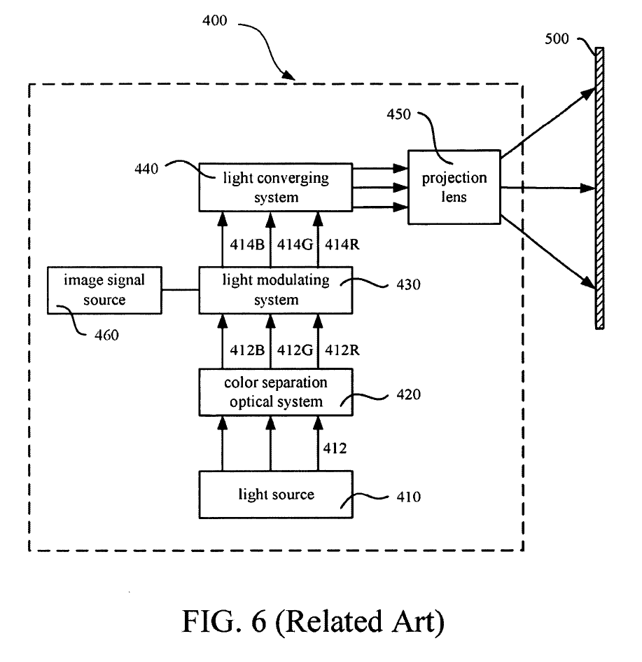

### DETAILED DESCRIPTION OF THE EMBODIMENTS

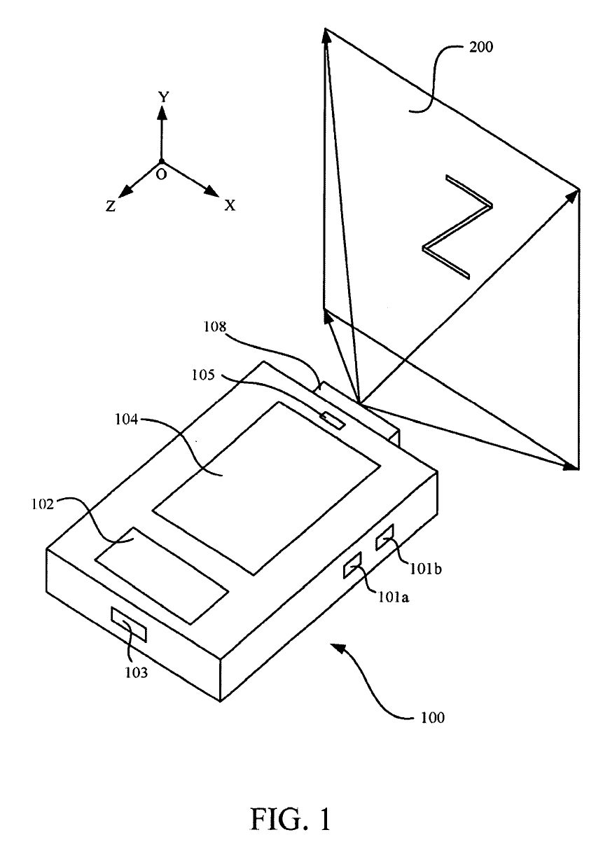

Referring to FIG. 1, a portable electronic device 100 in accordance with an embodiment of the present invention is shown. The portable electronic device 100 is a personal digital assistant (PDA) in the present embodiment. It should be understood that the portable electronic device 100 can be a mobile phone, a game player, and a notebook, among other devices.

The electronic device 100 includes an input system 102, a display system 104, an audio system (not labeled) and a projection system 108. The input system 102, such as a keyboard, is used to input commands. The commands input by the input system 102 are displayed via the display system 104 in order to easily determine whether the commands are correct. The display system 104 is also used to display functional menus that can be selected by users. The audio system includes a microphone 103 and a speaker 105. The microphone 103 and the speaker 105 are used to input and output audio signals, respectively. The projection system 108 is fixed to a top end of the electronic device 100 and is used to directly project colored images onto a screen 200. The screen 200 is located on a planar surface O-XY.

The electronic device 100 further includes an input port 101a and an output port 101b at a right lateral side thereof, such as universal serial bus (USB) ports and earphone ports, among others. The input system 102, the display system 104, the audio system, the projection system 108, the input and output ports 101a, 101b are electrically connected to a circuit board (not shown) in the electronic device 100.

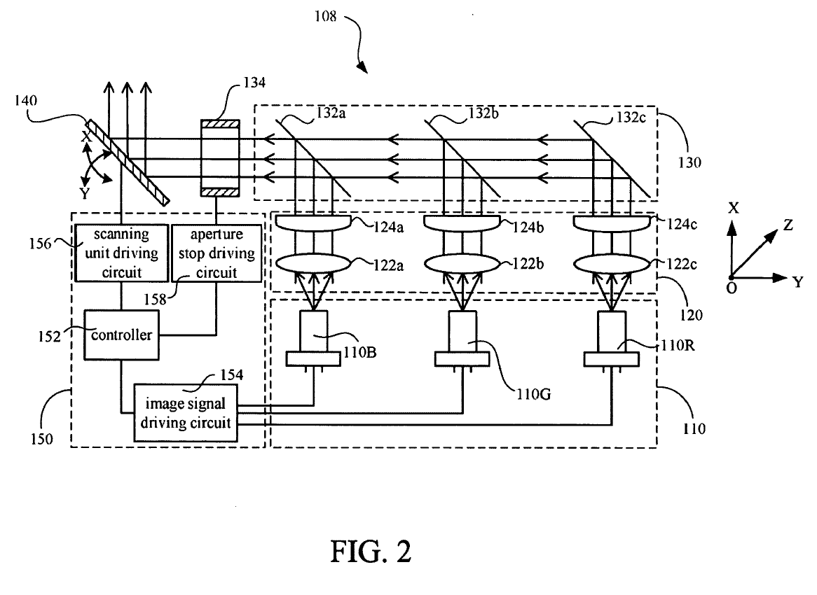

Referring to FIG. 2, the projection system 108 includes a light source 110, a light modulating unit 120, a light converging unit 130, a dynamic scanning unit 140 and a control circuit 150.

The light source 110 is used to provide a monochromatic, radial light. In the present embodiment, the light source 110 includes a red laser diode (LD) 110R for emitting red light, a green LD 110G for emitting green light, and a blue LD 110B for emitting blue light. The red, green and blue LDs 110R, 110G and 110B are controlled by the control circuit 150. The intensity of the emitted light changes according to an electric current of the control circuit 150. The operation of each of the red, green and blue LDs 110R, 110G and 110B can be separately controlled.

The light modulating unit 120 is used to collimate the monochromatic, radial light emitted from the light source 110 into parallel light. The light modulating unit 120 includes three collimating lenses 122a, 122b, 122c and three corresponding cylindrical lenses 124a, 124b, 124c. The collimating lens 122a and the cylindrical lens 124a are sequentially disposed in the optical path of the blue light emitted from the blue LD 110B to the light converging unit 130. Likewise, the collimating lens 122b and the cylindrical lens 124b are sequentially disposed in the optical path of the green light emitted from the green LD 110G to the light converging unit 130. The collimating lens 122c and the cylindrical lens 124c are sequentially disposed in the optical path of the red light emitted from the red LD 110R to the light converging unit 130. The monochromatic, radial lights emitted from the red, green and blue LDs 110R, 110G and 110B respectively pass through the corresponding collimating lenses 122c, 122b, 122a and the corresponding cylindrical lenses 124c, 124b, 124a, thereby being collimated into parallel light.

In practice, a divergence angle of the light emitted from each of the LD 110R, 110G and 110B with respect to a planar surface O-YZ is greater than a divergence angle of the light with respect to a planar surface O-XZ. Although the collimated light by the collimating lenses 122a, 122b and 122c is parallel to the planar surface O-XZ, there still is a divergence angle with respect to the planar surface O-YZ. The cylindrical lenses 124a, 124b and 124c are used to change the divergence angle with respect to the planar surface O-YZ. An aspect ratio of a beam spot shape of the light can be modulated into an expectant ratio according to an operating requirement, such as the shape of the screen 200 shown in FIG. 1.

The light converging unit 130 includes three band-pass filters 132a, 132b and 132c which have one-to-one relationships with respect to the cylindrical lenses 124a, 124b and 124c of the light modulating unit 120. The band-pass filter 132c reflects the red light incident thereon to the filter 132b. The band-pass filter 132b reflects the green light incident thereon to the filter 132a, and allows the red light reflected from the filter 132c to transmit through to the filter 132a. The band-pass filter 132a reflects the blue light incident thereon to the aperture stop 134, and allows the green and red lights from the filter 132b to transmit through to the aperture stop 134. As a result, the red, green and blue lights are combined after they transmit through the band-pass filter 132a.

The projection system 108 further includes an aperture stop 134. The aperture stop 134 is located between the light converging unit 130 and the dynamic scanning unit 140, so as to control the beam spot shape of the combined light. The aperture stop 134 is also used to appropriately omit stray light, thereby improving the resolution, acuity and contrast of the image projected onto the screen 200. In the present embodiment, the aperture stop 134 operates under a dynamic state. During remote projection, the aperture stop 134 is zoomed in to allow more light to transmit through, thereby improving the brightness of the image. During near projection, the aperture stop 134 is zoomed out to allow less light to transmit through, thereby improving the resolvable resolution and contrast of the image.

The dynamic scanning unit 140 is used to project the light transmitted from the aperture stop 134 onto the screen 200 (shown in FIG. 1). The dynamic scanning unit 140 is a 3D scanning mirror that can rotate about X-Y-Z reference axes. The dynamic scanning unit 140 is typically made of silicone based on micro electro mechanical system (MEMS) technology.

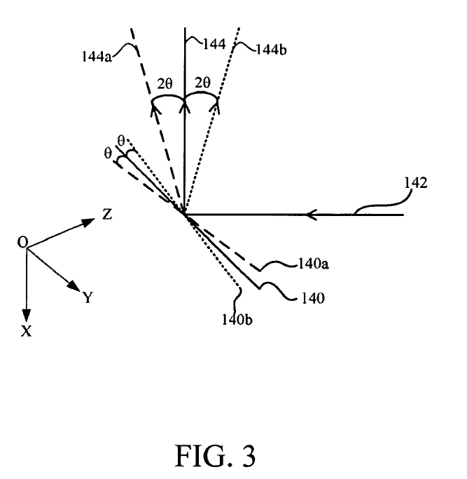

Referring to FIG. 3, incident light 142 transmitted from the aperture stop 134 is reflected by the dynamic scanning unit 140 along a direction 144, and then projected onto the screen 200. When the dynamic scanning unit 140 rotates at an angle θ along a counter-clockwise direction to a position indicated by 140a about the Y-axis, the incident light 142 is reflected along a direction 144a, which forms a counter-clockwise angle 2θ with respect to the direction 144. When the dynamic scanning unit 140 rotates at an angle θ along a clockwise direction to a position indicated by 140b about Y-axis in the planar surface O-XZ, the incident light 142 is reflected along a direction 144b, which forms a clockwise angle 2θ with respect to the direction 144. A projection range of the projection system 108 in the planar surface O-XZ is formed between the direction 144a and the direction 144b. Likewise, when the scanning unit 140 is rotated about X-axis in the planar surface O-YZ, a projection range of the projection system 108 in the planar surface O-YZ can be formed.

It should be understood that the dynamic scanning unit 140 can scan the image via an interlaced or progressive scanning manner.

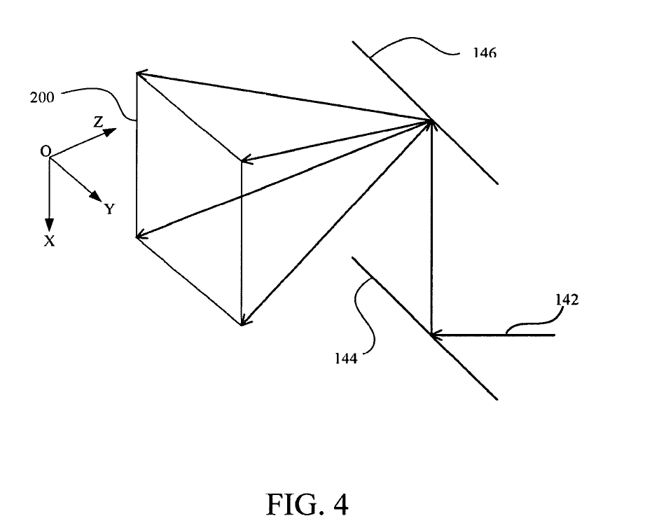

Alternatively, the dynamic scanning unit 140 can have other configurations. Referring to FIG. 4, a scanning unit in accordance with another embodiment of the present invention is shown. The scanning unit includes two 2D scanning mirrors 144 and 146. When the projection system is turned off, the scanning mirrors 144 and 146 are parallel to each other. When the projection system operates, the scanning mirror 144 merely rotates about the X-axis in the O-YZ planar surface, so as to scan the image in the O-YZ planar surface. The scanning mirror 146 merely rotates about the Y-axis in the O-XZ planar surface, so as to scan the image in the O-XZ planar surface. Since the typical image has a longitudinal width greater than a lateral width, a rotating angle of the scanning mirror 144 about the X-axis is greater than that of the scanning mirror 146 about the Y-axis. A rotating frequency of the scanning mirror 144 about the X-axis is different from that of the scanning mirror 146 about the Y-axis. Specifically, the rotating frequency of the scanning mirror 144 about the X-axis is less than that of the scanning mirror 146 about the Y-axis. The rotating frequencies of the scanning mirrors 144, 146 can be changed to satisfy different operating requirements.

Referring back to FIG. 2, the control circuit 150 includes a controller 152, an image signal driving circuit 154, a scanning unit driving circuit 156 and an aperture stop driving circuit 158. The image signal driving circuit 154, the scanning unit driving circuit 156 and the aperture stop driving circuit 158 electrically interconnects with the controller 152.

During operation of the projection system 108, the controller 152 converts video signals from the electronic device 100 into determinate image signals, and controls the image signal driving circuit 154 to output determinate electrical signals. The electric current used to control the red, green and blue LDs 110R, 110G and 110B is adjusted according to the determinate electrical signals. As a result, the intensity of the emitted light is changed along with the changes of the electric current of the red, green and blue LDs 110R, 110G and 110B. The controller 152 controls the scanning unit driving circuit 156 to output driving electrical signals. The rotating frequencies of the dynamic scanning unit 140 at different rotating directions, such as about the X-axis and the Y-axis, are modulated according to the driving electrical signals from the scanning unit driving circuit 156. The controller 152 controls the aperture stop driving circuit 158 to output driving electrical signals. The aperture stop 134 is modulated to zoom in or out according to the driving electrical signals from the aperture stop driving circuit 158, so as to obtain a required brightness, resolvable resolution, and contrast of the image.

In the projection system 108, the monochromatic LDs 110R, 110G and 110B serve as the light source 110. The image is projected onto the screen 200 by the dynamic scanning unit 140. There is no requirement for the conventional color separation optical system and projection lens, thereby simplifying the overall structure of the projection system 108. Thus, the projection system 108 can be conveniently integrated into the portable electronic device 100. Additionally, the LDs 110R, 110G and 110B used in the projection system 108 consume relatively small amount of energy and are not easily overheated. Accordingly, a heat dissipating device is not required, which further simplifies the overall structure and reduces the cost of manufacturing the projection system 108.

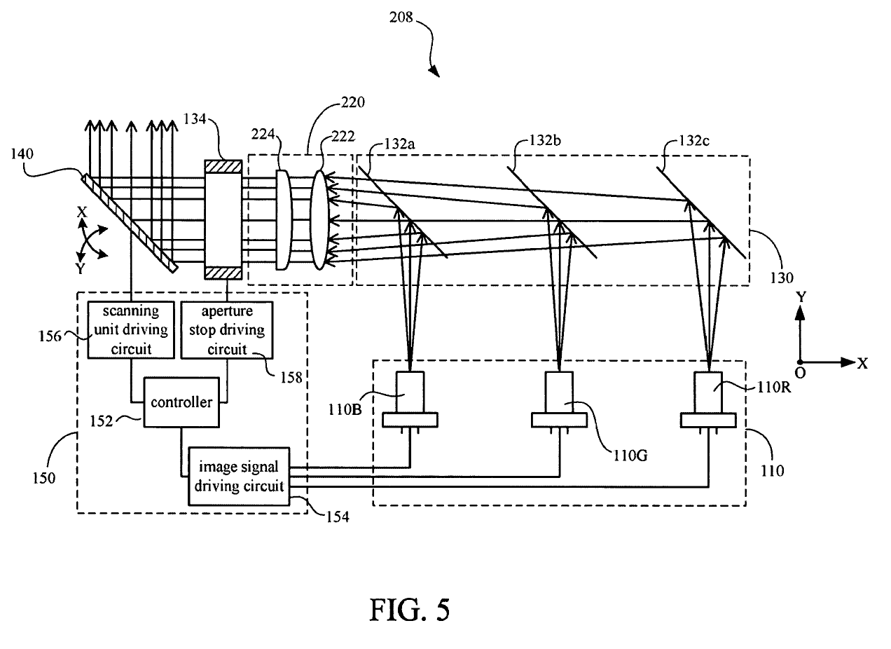

Referring to FIG. 5, a projection system 208 in accordance with another embodiment of the present invention is shown. The projection system 208 is similar to the projection system 108 shown in FIG.2. In the present embodiment, the light modulating unit 220 uses just one collimating lens 222 and one cylindrical lens 224, which are sequentially disposed in the optical path of the light transmitted from the light converging unit 130 to the aperture stop 134.

During operation of the projection system 208, the red, green and blue monochromatic lights emitted from the LDs 110R, 110G and 110B respectively transmit through and/or are reflected by the corresponding band-pass filters 132c, 132b and 132a of the light converging unit 130. The lights are combined into a single band of light via the light converging unit 130, and then are modulated by the modulating unit 220. The collimating lens 222 of the modulating unit 220 collimates the light into several beams of light, which are approximately parallel to each other. Meanwhile, the cylindrical lens 224 of the modulating unit 220 changes the divergence angle of the parallel light beams to satisfy different operating requirements. The parallel light beams transmitted from the light modulating unit 220 travel to the aperture stop 134, are modulated by the aperture stop 134, and then travel to the dynamic scanning unit 140. As a result, the dynamic scanning unit 140 projects the lights modulated by the aperture stop 134 onto the screen 200 (shown in FIG. 1).

It should be understood that the light source 110 may merely include a monochromatic LD selected from the group consisting of the red LD 110R, the green LD 110G and the blue LD 110B. Accordingly, the light converging unit 130 is not required in the projection system 108, 208. The monochromatic light emitted from the monochromatic LD is directly modulated by the light modulating unit 120, or 220, and then travels to the dynamic scanning unit 140 to be projected onto the screen 200. As a result, the overall structure of the projection system 108, 208 is further simplified.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A projection system comprising:
a light source for emitting at least one monochromatic light;
a light modulating unit capable of collimating the at least one monochromatic light into parallel light;
a dynamic scanning unit capable of reflecting and projecting the parallel light incident thereupon; and
a control circuit electrically connected with the light source and the dynamic scanning unit, the control circuit being capable of controlling the dynamic scanning unit to rotate at a rotating frequency.

2. The projection system of claim 1, wherein the dynamic scanning unit is a 3D scanning mirror, and is made based on MEMS technology.

3. The projection system of claim 2, wherein the rotating frequency of the dynamic scanning unit is different along different dimensions.

4. The projection system of claim 1, wherein the dynamic scanning unit includes two 2D scanning mirrors, and is made based on MEMS technology.

5. The projection system of claim 4, wherein the rotating frequency of the dynamic scanning unit is different along different dimensions.

6. The projection system of claim 1, wherein the dynamic scanning unit is made of silicone.

7. The projection system of claim 1, wherein the light modulating unit is located between the light source and the dynamic scanning unit, and comprises a collimating lens and a cylindrical lens.

8. The projection system of claim 1, further comprising a dynamic aperture stop located between the dynamic scanning unit and the light modulating unit.

9. The projection system of claim 8, wherein the control circuit comprises a controller, an image signal driving circuit, a scanning unit driving circuit and an aperture stop driving circuit, the image signal driving circuit, the scanning unit driving circuit and the aperture stop driving circuit being electrically interconnected with, and controlled by, the controller; and wherein the image signal driving circuit is capable of controlling the light source, scanning unit driving circuit is capable of driving the dynamic scanning unit, and the aperture stop driving circuit is capable of driving the dynamic aperture stop.

10. The projection system of claim 1, wherein the light source comprises at least two laser diodes electrically connected with the control circuit, each of the at least two laser diodes emits a monochromatic light.

11. The projection system of claim 10, comprises a light converging unit located between the light source and the dynamic scanning unit, the light converging unit comprising at least two band-pass filters respectively facing the at least two laser diodes.

12. The projection system of claim 11, wherein the light modulating unit is located between the light converging unit and the dynamic scanning unit, and comprises a collimating lens and a cylindrical lens.

13. The projection system of claim 11, wherein the light modulating unit is located between the light converging unit and the light source, the light modulating unit comprising at least two collimating lenses and at least two cylindrical lenses respectively facing the corresponding laser diodes.

14. A portable electronic device comprising:
an input system for inputting commands;
a display system for displaying the commands inputted by the input system; and
a projection system, the projection system comprising:
a light source for emitting at least one monochromatic light;
a light modulating unit capable of collimating the at least one monochromatic light into parallel light;
a dynamic scanning unit capable of reflecting and projecting the parallel light incident thereupon; and
a control circuit electrically connected with the light source and the dynamic scanning unit, the control circuit being capable of controlling the dynamic scanning unit to rotate at a rotating frequency.

15. The portable electronic device of claim 14, wherein the dynamic scanning unit is made based on MEMS technology, the dynamic scanning unit is either a 3D scanning mirror or includes two 2D scanning mirrors.

16. The portable electronic device of claim 14, wherein the dynamic scanning unit is made of silicone.

17. The portable electronic device of claim 14, wherein the light modulating unit is located between the light source and the dynamic scanning unit, and comprises a collimating lens and a cylindrical lens.
